(19) United States
(12) Patent Application Publication
(10) Pub. No.: US 2022/0398488 A1
(43) Pub. Date: Dec. 15, 2022

(54) MACHINE-LEARNED MODEL SCORING TECHNIQUE FOR REDUCING MODEL INVOCATIONS

(71) Applicant: Microsoft Technology Licensing, LLC, Redmond, WA (US)

(72) Inventors: Zhenjie ZHANG, Saratoga, CA (US); Sanjay Reddy SATTI, San Jose, CA (US); Santhosh Kumar KUCHOOR, Dublin, CA (US); Wesley Kevin SUN, East Palo Alto, CA (US); Guanyu WANG, Santa Clara, CA (US); Sai MADHAVAN, San Francisco, CA (US); Michelle Seeton GALEMMO, Albany, CA (US); Haifeng ZHAO, San Jose, CA (US)

(21) Appl. No.: 17/346,196

(22) Filed: Jun. 11, 2021

(51) Int. Cl. G06N 20/00

(52) U.S. Cl. CPC G06N 20/00

(57) ABSTRACT

Machine-learned model scoring techniques for reducing model invocations are provided. In one technique, first values for non-pair-specific interaction features that are associated with a first entity are identified. Second values for pair-specific interaction features that are associated with (a) the first entity and (b) a second entity that is different than the first entity are identified. A machine-learned model that has been trained based on the non-pair-specific interaction features and the pair-specific interaction features generates a first score based on the first values. The machine-learned model also generates a second score based on the first values and the second values. A final score for the first entity-second entity pair is computed based on the first score and the second score. Based on the final score, data about the first entity is transmitted over a computer network to a computing device associated with the second entity.

### TECHNICAL FIELD

The present disclosure relates generally to machine learning and, more specifically to, a model scoring technique that normalizes an entity score and reduces the number of model invocations.

### BACKGROUND

A computer-based model is a computer program that is designed to simulate what might happen in a situation. Computer-based models (or simply “models”) are used in many ways, including in astronomy, economics, and sciences, such as physics and biology. Predicting online actions of users is a desired goal for many enterprises. If a model is accurate at predicting user behavior online, then an enterprise may adjust its practices in order to influence online user behavior.

However, a model's accuracy is only as good as the assumptions built into the model. A rules-based model, which has handcrafted rules, is subject to significant bias of the model creators. One approach for predicting online user behavior is to analyze online searches of the users and map keywords in those searches to certain entities, such as companies. However, many keywords are ambiguous without more knowledge of the user or the context. For example, if a user specifies “chips,” it is not clear whether the user is interested in potato chips, hardware chips, wood chips, or another type of chip. Also, the user might have performed the search for a variety of reasons that are unrelated to acquiring chips, such as doing research for a school report or simply acquiring general knowledge. Regardless, a hardware chip manufacturing company may be interested in contacting the user simply because the user entered “chips” in a search query. However, such efforts to reach out to the user would likely constitute a waste of time and resources since the chances that the user is interested in acquiring hardware chips is very low.

Though machine-learned models still require user input to specify and define the features upon which the models are trained, such models are subject to much less bias. A machine learning algorithm learns which features are important or predictive and which features are not. However, in many cases, the amount of training data and/or feature data is limited; thus, reducing the utility of machine-learned models.

Even with a significant amount of training data and feature data, a prediction of a user's behavior based on a machine-learned model might not be reflective of the user's true intent because each individual user is unique. For example, two particular online activities by one user with respect to an entity may signal an intent to engage that entity while fifty online activities by another user with respect to that entity may not signal such an intent. As a specific example, a first user selects just one content item associated with a particular entity while a second user selects (e.g., clicks on) hundreds of content items associated with the particular entity. Based on respective frequencies of user selections and the training data, a machine learning algorithm may generally “learn” that more selections by a user of an entity's content items eventually results in the user performing a particular action with respect to the entity. However, in this particular case, it happens to be the case that the first user is the one who is more likely to perform the particular action with respect to the particular entity.

In order to obtain a better understanding of each user's intent with respect to the particular entity, it would be necessary to invoke the model for each of multiple pairs, each pair consisting of the user and another entity. For example, it may be the case that a particular user interacts with multiple entities equally frequently without performing a particular action when the “average” user (indicated in the training data) only interacts infrequently with an entity before performing the particular action. Because the machine-learned model is trained on the “average” user, the machine-learned model may predict, based on the particular user's interactions with respect to one entity, that the particular user is likely to perform the particular action with respect to that entity. Thus, to mitigate this result, the model is invoked with respect to the particular user and multiple other entities to determine that the particular user has no more interest in the entity compared to the multiple other entities. However, the time and computing resources to invoke the machine-learned model for each possible pair would be significant, especially when the number of entities is in the hundreds, thousands, or tens of thousands. Therefore, predicting online user behavior may be improved with not only sufficient training data and feature data, but also by reducing the consumption of computing resources without sacrificing model accuracy.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example system for training and invoking a machine-learned model, in an embodiment;

FIG. 2 is a flow diagram that depicts an example process for generating prediction scores using a machine-learned model, in an embodiment;

FIG. 3 is a flow diagram that depicts an example process for generating prediction scores using the two-model approach, in an embodiment;

FIG. 4A and FIG. 4B are example graphics and user interfaces that indicate final scores representing interest related to a pair of entities, in an embodiment;

FIG. 5 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method for leveraging a machine-learned model to generate accurate scores that reduces the number of model invocations are provided. In one approach, machine learning techniques are implemented to train a model based on training data pertaining to interactions between target entities and source entities. The model is invoked twice: once based on values of non-interaction features of a target entity and a second time based on the values of the non-interaction features and values of interaction features pertaining to the target entity and a source entity. Each invocation of the model generates a score, from which a final score is computed. The final score is a more accurate prediction of whether the target entity is going to perform a particular action, such as select a content item, fill out an electronic form, or accept an electronic message.

Embodiments improve computer technology related to machine-learned models. Other approaches relied on generating a score between the target entity and each candidate source entity in order to have an accurate understanding of the pair consisting of the target entity and a particular source entity. In contrast, embodiments rely on invoking the same model twice in order to generate an accurate score for a target entity-source entity pair, but each model invocation is with different sets of feature values.

### System Overview

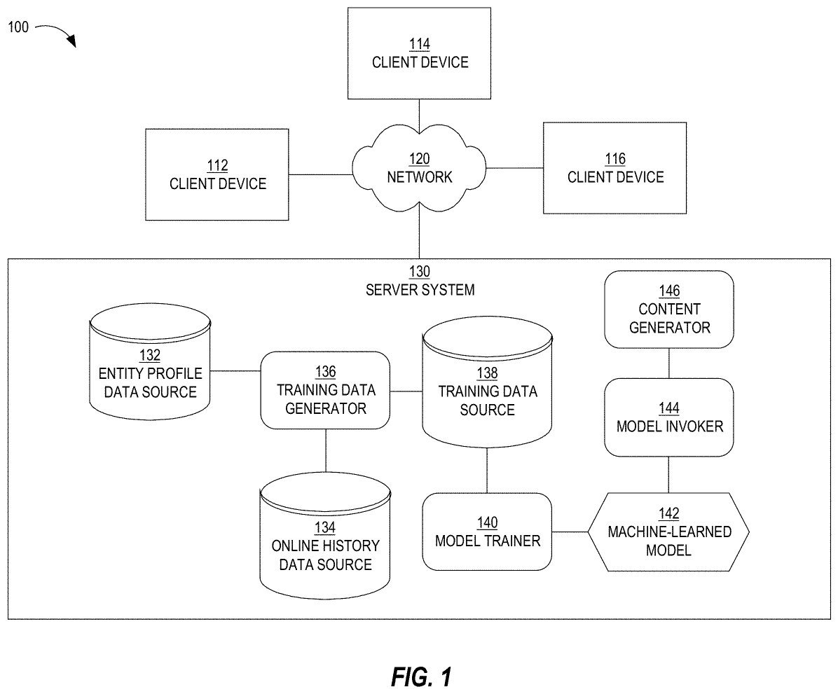

FIG. 1 is a block diagram that depicts an example system 100 for training and invoking a machine-learned model, in an embodiment. System 100 includes client devices 112-116, a network 120, and a server system 130. Although only three client devices are depicted, many client devices may be communicatively coupled to server system 130 through network 120 and/or other networks (not depicted). Server system 130 comprises one or more computing elements that perform the operations described herein as being performed by server system 130.

Network 120 is a computer network, examples of which include a local area network (LAN), a wide area network (WAN), and the Internet.

Examples of client devices 112-116 include a desktop computer, a laptop computer, a tablet computer, a wearable device, a video game console, and a smartphone.

A client device may receive content from server system 130 in response to transmitting a content request over network 120 to server system 130. Examples of a content request include a search request and a page request. A search request includes one or more query terms that are entered through the client device, such as through a physical keyboard of the client device or a graphical keyboard that is presented on a touchscreen display of the client device. A page request includes a uniform resource locator (URL) of a resource (e.g., web page) that server system 130 hosts.

A client application executing on the client device transmits the content request to server system 130. Examples of such a client application include (1) a web application that executes within a web browser that executes on the client device and (2) a native application that is installed on the client device and is configured to communicate with server system 130.

A client device may receive content from server system 130 not in response to a content request from the client device. For example, server system 130 identifies content that server system 130 determines is relevant to a user of the client device and sends, to the client device or to an account of the user, a notification of the content in the form of an instant message, a text message, an email message, a push notification, or an in-app notification. Later, the user, operating the client device or another device, views the notification and determines whether to select any links to content found in the notification, the links referencing content hosted by server system 130 and/or another computer system.

### Server System

Server system 130 includes an entity profile data source 132, an online history data source 134, a training data generator 136, a training data source 138, a model trainer 140, a machine-learned model 142, a model invoker 144, and a content generator 146. In an embodiment, server system 130 hosts an online service that users operating client devices 112-116 can access over network 120. An example of an online service is a social networking service where registered users create profiles, view other users' profiles, compose and send electronic messages to other users, post content, perform viral actions (e.g., like, comment, share) on user-generated content, and create connections with other registered users, which connections allow for the sharing of electronic content. An example of a social networking service is one provided by LinkedIn.

Each of components 136, 140, 144, and 146 is implemented in software, hardware, or a combination of software and hardware. The functionality of components 136, 140, 144, and 146 may be implemented in a single program or across multiple programs in order to adhere to component-based software engineering principles.

Components 136, 140, 144, and 146 may be implemented on the same computing device or on multiple computing devices. For example, each of components 136, 140, 144, and 146 may be implemented on different computing devices that are communicatively coupled to each other over a computer network, such as a local area network (LAN), wide area network (WAN), or the Internet.

### Entity Profile Data Source

Entity profile data source 132 stores multiple entity profiles. Each entity profile in entity profile data source 132 is provided by a different user. Example entities for which profiles are maintained include users, groups of users, and organizations (e.g., companies, associations, government agencies, etc.). Each entity profile is provided by a different user or group/organization representative.

An organization profile may include an organization name, a website, one or more phone numbers, one or more email addresses, one or more mailing addresses, a company size, a logo, one or more photos or images of the organization, an organization size, and a description of the history and/or mission of the organization.

A user profile may include a first name, last name, an email address, residence information, a mailing address, a phone number, one or more educational/academic institutions attended, one or more academic degrees earned, one or more current and/or previous employers, one or more current and/or previous job titles, a list of skills, a list of endorsements, and/or names or identities of friends, contacts, connections of the user, and derived data that is based on actions that the user has taken. Examples of such actions include jobs to which the user has applied, views of job postings, views of company pages, private messages between the user and other users in the user's social network, and public messages that the user posted and that are visible to users outside of the user's social network (but that are registered users/members of the social network provider). As described in more detail herein, information about such actions may be stored separately, such as in online history data source 134.

Some data within a user's profile (e.g., work history) may be provided by the user while other data within the user's profile (e.g., skills and endorsement) may be provided by a third party, such as a “friend,” connection, or colleague of the user.

Server system 130 may prompt users to provide profile information in one of a number of ways. For example, server system 130 may have provided a web page with a text field for one or more of the above-referenced types of information. In response to receiving profile information from a user's device, server system 130 stores the information in an account that is associated with the user and that is associated with credential data that is used to authenticate the user to server system 130 when the user attempts to log into server system 130 at a later time. Each text string provided by a user may be stored in association with the field into which the text string was entered. For example, if a user enters “Sales Manager” in a job title field, then “Sales Manager” is stored in association with type data that indicates that “Sales Manager” is a job title. As another example, if a user enters “Java programming” in a skills field, then “Java programming” is stored in association with type data that indicates that “Java programming” is a skill.

In an embodiment, server system 130 stores access data in association with a user's account. Access data indicates which users, groups, or devices can access or view the user's profile or portions thereof. For example, first access data for a user's profile indicates that only the user's connections can view the user's personal interests, second access data indicates that confirmed recruiters can view the user's work history, and third access data indicates that anyone can view the user's endorsements and skills.

In an embodiment, some information in a user profile is determined automatically by server system 130 (or another computing system). For example, a user specifies, in his/her profile, a name of the user's employer. Server system 130 determines, based on the name, where the employer and/or user is located. If the employer has multiple offices, then a location of the user may be inferred based on an IP address associated with the user when the user registered with a social network service (e.g., provided by server system 130) and/or when the user last logged onto the social network service.

Embodiments are not limited to the type of data that server system 130 stores or the type of requests that client devices 112-116 might submit. For example, another data source included in server system 130 may include information about multiple content delivery campaigns, where each campaign is associated with a single party or entity that provides the campaign (or “campaign provider”). An example of such content is an advertisement and an example of a campaign provider is an advertiser. An individual representing a campaign provider and operating client device 112 may submit one or more requests for information about content delivery campaigns that are being managed by server system 130, such as how the content delivery campaigns are performing, which ones are still active.

Another example of a data source included in server system 130 is an opportunity data source that stores information about multiple opportunities, such as job postings. Information about an opportunity includes a name of a provider of the opportunity (e.g., a company name), an industry name, a job title, a job description, a set of skills required to be accepted for the opportunity, a location of where the job is to be performed, and an assessment (e.g., a set of questions) to complete in order to apply for the opportunity.

### Online History Data Source

Online history data source 134 stores information about the online history of each user of multiple users. The online history may comprise search history (e.g., key words entered into a search field), search result history (e.g., sets of search results that were presented to the user in response to searches initiated by the user), page view history (e.g., which pages the user viewed or was presented), notification history (e.g., a set of notifications presented to the user, whether push notifications or in-app notifications), recommendation history (e.g., a set of recommendations that were presented to the user), and/or user interaction history (e.g., identification of links, video items, non-video content items, search results, notifications, recommendations, job postings, and/or graphical options that the user selected).

Information about each action performed by a user or performed by server system 130 relative to a user may be stored in a record that uniquely identifies the user (e.g., using a user identifier). A record may also include a timestamp that indicates a date and/or time of the corresponding action. For search history, a record includes the one or more search terms that a user entered or selected. For search result history, a record may include (a) a list of entities (e.g., company names, job postings) that were presented to the user in a search result list and, optionally, (b) the search criteria that was used to identify the entities in the list. For page view history, a record may include a page identifier of a web page that was presented to the user or that the user requested.

For notification history, a record may include a notification type (e.g., work anniversary, a new job of a friend/connection, a new role/position of a friend/connection, a posting from a connection or followed entity, an upcoming event), an entity name that is identified in the notification that was presented, and other content in the notification.

For recommendation history, a record may include a recommendation type (e.g., a recommended job, a recommended online learning course, a recommended new friend/connection, a recommended person or company to follow), an entity (e.g., person or company) name that is the subject of the recommendation, and other content in the recommendation. For user interaction history, a record may include a type of interaction (e.g., click, view for less than two seconds, view for more than two seconds, highlight, option selection), a type of object with which interacted (e.g., link, notification, recommendation, video item, search result, search option), text associated with the interaction, and name of entity (e.g., company name or person name) that is the subject of the interaction.

In an embodiment, records in online history data source 134 are aggregated to produce aggregated data on a per user-basis. For example, records pertaining to user A are organized so that they are logically (or physically) stored together, thus, enabling faster access when information about user A is required. In this way, the entirety of online history data source 134 does not need to be searched to find records pertaining to a particular user when information about that particular user is requested. The aggregated data may be stored separate from online history data source 134 and used for further processing, as described herein.

In a related embodiment, records in online history data source 134 are aggregated to produce aggregated data on a per-organization (or per-group) basis. For example, records pertaining to users A-D (who shared a job function at Company X) are identified and a new record is generated that combines the activities of users A-D into the new record. For example, the number of messages that users A-D send to users of various organizations over a particular period of time is computed and stored in a new (aggregated) record.

Additionally or alternatively to record aggregation, an index based on user identifier may be generated to enable fast retrieval of records in online history data source 134 pertaining to each user. (Similarly, an index based on organization identifier or group identifier may be generated to enable fast retrieval of records in online history data source 134 pertaining to each organization and/or group.) However, when new records are added to online history data source 134, the index needs to be updated to account for the new records, unless maintaining a stale index is acceptable.

### Target Entities and Source Entities

A target entity may be an individual user or an organization. The target entity may be a registered entity of server system 130. Examples of an organization include a company, an academic institution, a charitable organization, a government agency, an association, or any grouping of people who share one or more attributes in common (“cohort”), such as a common geographical location, a common employer, a common job function, a common industry, a common demographic trait, and/or a common interest. Such commonalities may be determined from entity profile data source 132. A target entity is the entity for which a prediction of a particular action is made. For example, an output of machine-learned model 142 reflects a prediction of whether the target entity is going to perform an online action, such as a filling out an electronic form.

A source entity may be (or be associated with) a user, an organization, a group of people who share one or more attributes in common (“cohort”), a product, or a service. Thus, embodiments may be used to identify target entities (or potential acquirors) of a source entity (or a product). In some invocations of machine-learned model 142, output thereof reflects of a prediction of whether a target entity will perform a particular action that is associated with the source entity. In such scenarios, input to model 142 includes feature values pertaining to the source entity.

Embodiments are not limited to the type of combination of a type of target entity and a type of source entity. Example types of combinations include company-company, user-user, user-company, company-user, cohort-cohort, company-cohort, cohort-product, company-product, and user-product.

### CRM Data Source

In an embodiment, data about entities and some actions that are described in online history data source 134 originate from a data source (not depicted) that is remote relative to server system 130. There may be multiple remote data sources, each corresponding to a different source entity. For example, a source entity may host or have access to a customer relationship management (CRM) database that stores records, each about a different target entity, such as a person, company, or account. A CRM record includes entity information, such as (depending on the type of entity) name (e.g., first name and last name, or company name), email address, phone number, mailing address, job title, job function, size, revenues, industry, geographic location. A CRM record may also include event information that indicates whether certain events have occurred, such as whether the target entity responded to a meeting request, whether a meeting with the target entity was scheduled, whether a meeting with the target entity took place, whether a contract was signed, and/or whether the target entity made an acquisition (e.g., purchase) of an item provided by the source entity. A CRM record may also include status information that indicates a status of the target entity, such as whether the target entity is a candidate buyer, whether there are current efforts to reach out to the target entity, whether there are active communications with the target entity, whether an acquisition is pending, whether an acquisition is complete, whether the account associated with the target entity is open, and/or whether the account associated with the target entity is closed.

A remote (e.g., CRM) data source may be merged with entity profile data source 132 in order to supplement an entity record with additional information from records of the remote data source. Merging involves matching one or more records from the remote data source to a record of entity profile data source 132. Matching may involve comparing email addresses, phone numbers, names, industry, etc.

Thus, from supplemented entity records or from remote data records, training instances may be generated and used to train a machine-learned model (as described in more detail herein) and scoring instances may be generated and used to invoke the machine-learned model. A training/scoring instance may be generated from a single remote data record or multiple remote data records. For example, if a single CRM record corresponds to a single user associated with a target entity and there are multiple CRM records that correspond to such users, then multiple CRM records may be aggregated to generate a single aggregated record for the target entity.

### Machine Learning

Machine learning is the study and construction of algorithms that can learn from, and make predictions on, data. Such algorithms operate by building a model from inputs in order to make data-driven predictions or decisions. Thus, a machine learning technique is used to generate a statistical model that is trained based on a history of attribute values associated with users and regions. The statistical model is trained based on multiple attributes (or factors) described herein. In machine learning parlance, such attributes are referred to as “features.” To generate and train a statistical model, a set of features is defined and a set of training data is generated.

Embodiments are not limited to any particular machine learning technique for generating or training a model. Example machine learning techniques include linear regression, logistic regression, random forests, naive Bayes, neural networks, and Support Vector Machines (SVMs). One type of model is one that predicts a classification probability, which, in this case, is the probability of the target entity having the intent to engage a source entity. However, outputs from other types of models may be converted to a probability.

Advantages that machine-learned models have over rule-based models include the ability of machine-learned models to output a probability (as opposed to a number that might not be translatable to a probability), the ability of machine-learned models to capture non-linear correlations between features, and the reduction in bias in determining weights for different features.

### Training Data Generator

Training data generator 136 generates training data for training machine-learned model 142 and stores the training data in training data source 138. Training data comprises multiple training instances, each including a set of feature values and a label. Training data generator 136 accepts a definition of machine-learned model 142 and generates the training instances based thereon. The definition defines features (and, therefore, the input) of machine-learned model 142. Machine-learned model 142 comprises two main types of features: interaction features and non-interaction features.

### Non-Interaction Features

A non-interaction feature is one that does not pertain to interactions between a target entity and a source entity. In other words, a non-interaction feature is a feature that only pertains to the target entity and no other entity, such as an industry of the target entity (if the target entity is a group or organization), a geographic location of the target entity, a size of the target entity (if the target entity is a group or organization), a public/private status of the target entity (if the target entity is a company), revenue of the target entity, and other profile attributes of the target entity potentially found in entity profile data source 132. Other examples of such a feature pertain to activities of the target entity (or users associated with the target entity if the target entity is not a user) include a number of logins to an online service (e.g., a social networking service), an average session length of each session with the online service, a number of webpages that the target entity (or associated users) visited, and a number of content items (presented on the online service) that the target entity (or associated users) selected.

### Non-Pair-Specific Interaction Features

There are at least two types of interaction features: entity pair-specific interaction features and non-pair-specific interaction features. A non-entity-specific interaction feature is a feature that pertains to interactions between the target entity and multiple source entities. In the following examples of such features, reference to “target entity” may be replaced with “users associated with the target entity” if the target entity is a group or organization:
a. a number of messages that the target entity has sent to others,
b. a number of content items of a certain type that were presented to the target entity selected,
c. a number of content items the target entity selected (e.g., clicked),
d. a content item selection rate (e.g., a click through rate) of the target entity,
e. a number of video items that were presented to the target entity,
f. a number of video items that the target entity viewed for a minimum period of time,
g. a video view rate of the target entity,
h. a number of new connections made between the target entity and other users,
i. a number of electronic forms presented to the target entity,
j. a number of electronic forms that the target entity has filled out,
k. a form fill rate of the target entity,
l. a number of user or organization profile views by the target entity,
m. a number of product review pages viewed by the target entity,
n. a number of reviews (of products) left by the target entity,
o. a number of connection requests by the target entity,
p. a number of follows of source entities by the target entity,
q. a number of follows of other users by the target entity,
r. a number of actions (e.g., posting, clicking on links to an organization website, clicking on tabs) performed on organization profile pages by the target entity,
s. a number of posts viewed by the target entity,
t. a number of views and other engagement, by the target entity, of posts that mention other entities (where example types of other engagement include likes, comments, and shares),
u. a number of searches (initiated by the target entity) that include a name of another entity,
v. a number of searches (initiated by the target entity) for entities related to a source entity,
w. a number of searches (initiated by the target entity) that specify an industry, and
x. a number of searches (initiated by the target entity) of events,
y. a number of sessions that the target entity has had with an online service,
z. a number of sessions that the target entity has had with the online service using a certain type of device (e.g., desktop, mobile, laptop).

Each of these features may correspond to activity that occurred in a specific time. For example, the number of posts viewed by a target entity may be limited to views in the last day, the last week, or the last month. Also, multiple features (of the same type) of model 142 may corresponding to different time periods. For example, one feature is the number of connection requests made by a target entity in the last day and another feature is the number of connection requests made by the target entity in the last month.

### Entity Pair-Specific Interaction Features

An entity pair-specific interaction feature is a feature that pertains to interactions between the target entity and a specific source entity. Examples of entity pair-specific interaction features are ones described above with reference to non-pair-specific interaction features, except that the interaction is between a target entity and a single source entity. Therefore, machine-learned model 142 may comprise non-interaction features and both types of interaction features. For example, a first feature of model 142 is a number of new connection requests made by the target entity in the last month and a second feature of model 142 is a number of new connection requests made by the target entity to users associated with a specific source entity in the last month. The value of the first feature should be greater than (or equal to) the value of the second feature. Additionally, an “interaction” between a target entity and a source entity may be a common attribute, such as being associated with the same industry, the same country, the same state, etc.

Also, for a training instance that includes a value for a pair-specific interaction feature where the interaction is between a particular target entity and a particular source entity, the recorded action (or non-action), which is reflected in the label of the training instance, is an action that the particular target entity performed (or did not perform) relative to the particular source entity. For example, if the action is filling out an electronic form, then the label indicates whether the corresponding target entity filled out an electronic form from the corresponding source entity. If so, then the label may be ‘1’; if not, then the label may be ‘0’.

### Contextual Features

An additional type of feature of machine-learned model 142 may include contextual features. Example contextual features include features (1) about a time of day, a day of the week, and a type of computing device (e.g., desktop or mobile) that user(s) associated with the target entity operate(s) when some of the interactions by the target entity occur, and (2) attributes and/or identifies of entities on a page that the target entity is viewing.

### Training Instances

Each training instance includes a set of feature values pertaining to a target entity. As described herein, some feature values may correspond to interaction features and other feature values may correspond to non-interaction features. Also as described herein, each training instance also includes a label that indicates whether the target entity performed a particular action relative to a particular source entity that is subject of the one or more entity-specific interaction features.

Examples of actions that a target entity (or an associated user) performs relative to a source entity (or an associated user or entity, such as a product) include filling out an electronic (e.g., web) form that is associated with (e.g., originated from) the source entity, responding to an electronic message from the source entity, selecting a content item associated with (e.g., provided/generated by, mentions) the source entity, scheduling a meeting with the source entity, meeting with the source entity, signing a contract with the source entity, watching at least three seconds of a video associated with (e.g., that mentions) the source entity, acquiring (e.g., purchasing) a product/service manufactured/hosted by the source entity, selecting a notification about (e.g., mentions) the source entity, and accepting an invitation to connect with the source entity.

### Raw and Derived Features

Some features may be “raw features” whose values may be retrieved from storage without requiring additional processing or computing, such as profile attributes from entity profile data source 132 and online activity from online history data source 134. Some features may be “derived features” whose values are derived (or computed) based on one or more raw features and/or another derived feature. For example, a derived feature is a number of messages that users associated with a target entity composed and sent in the last week. In order to compute a value for this derived feature, training data generator 136 searches entity profile data source 132 for records that include a target entity identifier of the target entity that is subject of the training instance. Once the records are identified, training data generator 136 retrieves the user identifiers in those records. With those user identifiers, training data generator 136 identifies records in online history data source 134 that include: (1) a message sent type; (2) a date that is within the week in question; and (3) a user identifier in the set of user identifiers. Thus, depending on the definition of a derived feature, generating a value for the derived feature may involve searching both entity profile data source 132 and online history data source 134.

### Training Instance Versus Scoring Instance

A training instance is a combination of a set of feature values and a label that is used to train a model, while a scoring instance is a set of feature values (without any label) and is used to invoke a model. Thus, a scoring instance is input to the model. At one point in time, a set of feature values corresponding to a target entity-source entity pair is used to invoke a model and, later, is used to generate a training instance to train a new model (or re-train an existing model).

Training data generator 136 may use timing information to determine whether to generate a training instance or a scoring instance from one or more records that originate from online history data source 134 and, optionally, other data sources, such as one or more CRM databases. For example, if the status of a target entity indicated in a CRM record has not changed for a certain period of time (e.g., three months), then a training instance is generated based on the CRM record, regardless of whether the target entity performed the action in question relative to the source entity in question. Otherwise, a scoring instance is generated based on the CRM record and the machine-learned model 142 is invoked based on the scoring instance as input. As another example, if the status indicated in a CRM record is “closed,” then a training instance is generated, regardless of whether the corresponding target entity performed the action in question relative to the source entity in question.

Training data generator 136 may use event information to determine whether to generate a training instance or a scoring instance. For example, if a target entity (or an associated user) was presented with an electronic form from a source entity at least three times without filling out the form, then a negative training instance is generated; otherwise a scoring instance is generated.

### Model Trainer

Model trainer 140 implements one or more machine learning techniques to train machine-learned model 142 based on training data from training data source 138. Machine-learned model 142 may be a classification model or a regression model.

Initially, the number of features that are considered for training may be significant. After training a machine-learned model and validating the model, it may be determined that a subset of the features have little correlation or impact on the final output. In other words, such features have low predictive power. Thus, machine-learned weights for such features may be relatively small, such as 0.01 or −0.001. In contrast, weights of features that have significant predictive power may have an absolute value of 0.2 or higher. Features with little predictive power may be removed from the training data. Removing such features can speed up the process of training future models and computing output scores.

### Model Invoker

Model invoker 144 invokes machine-learned model 142 in response to a request from another component of server system 130, such as content generator 148. A request to model invoker 144 may include one or more entity identifiers, such as a user identifier for which a recommendation or a notification is to be generated based on output from machine-learned model 142, an organization identifier that identifies an organization that may be of interest to another organization, a video item identifier that identifies a video item that may be of interest to a user, a job posting identifier that identifies a job posting that may be the subject of a recommendation to a user, and/or an article identifier that identifies an online article that may be of interest to a user.

In an embodiment, a request includes multiple entity identifiers, such as one source entity identifier and one or more target entity identifiers.

Model invoker 144 uses the received entity identifier(s) to obtain feature values for machine-learned model 142. Such obtaining may involve retrieving, based on an entity identifier, data from entity profile data source 132, retrieving, based on the entity identifier, data from online history data source 134, and, optionally, generating some of the feature values from the retrieved data. Generating a feature value may involve computing an aggregated number based on multiple data items from the retrieved information, such as counting a number of messages that have been sent by a target entity to multiple source entities. A set of feature values that is retrieved based on a set of entity identifiers is stored in a scoring instance and has a certain order or schema that is dictated by model 142. With either a position identifier or a field name (from an order or a schema), model invoker 144 can identify the appropriate feature values. Invoking model 142 results in inputting the scoring instance into machine-learned model 142, which generates an output or score. The output may indicate a level of interest by the target entity generally (if the scoring instance does not include entity-specific interaction features) or a level of interest by the target entity in a specific source entity (if the scoring instance does include entity-specific interaction features). The output may reflect a likelihood (or probability) that the target entity will perform a particular action, for which model 142 is optimized.

### Final Score

In an embodiment, a final score for a target entity-source entity pair is generated by computing a ratio between a source entity-specific score and a general target entity score. Machine-learned model 142 outputs the source entity-specific score based on non-interaction features and both types of interaction features. Machine-learned model 142 also outputs the general target entity score based on non-interaction features and non-entity-specific interaction features. The final score may be used to determine whether to present, on a computing device, an identity of the target entity (e.g., a name) to the source entity (or a representative thereof). For example, if the final score is above a certain threshold, then an identity of the target entity (and, optionally, the final score and/or a graphic that is based on the final score) is transmitted over a computer network to a computing device of the source entity.

Additionally, the final scores of multiple target entity-source entity pairs (where the source entity is the same in each pair) may be used to rank the target entities and select the target entities with the top N final scores.

The two components of a final score may express meanings other than probability. For example, a final score may express a ratio of expected ROI over a baseline.

### Content Generator

Content generator 146 generates content to transmit to client devices 112-116 over network 120. Although only one content generator is depicted, server system 130 may include multiple content generators. For example, one content generator may generate recommendations, another content generator may generate notifications, another content generator may generate search results, and another content generator may generate web pages.

In an embodiment, content generator 146 calls, or sends requests to, model invoker 144. Content generator 146 (or another component of server system 130) generates content for presentation on a computing device based on one or more scores output by machine-learned model 142. For example, content generator 146 determines an identity of a source entity (or associated user) that is requesting content from server system 130. Based on the identity of source entity, content generator 146 identifies multiple candidate target entities. Candidate identification may involve identifying target entities that are in the same industry as the source entity or that are identified in a record from a CRM database of the source entity. Content generator 146 sends, to model invoker 144, a request that includes an identifier for each candidate target entity and model invoker 144, in turn, invokes model 142 for each candidate target entity. Each invocation includes values for entity-specific interaction features (pertaining to the source entity) and values for non-entity-specific interaction features. Such a first set of invocations result in a source entity-specific score for each candidate target entity.

Model invoker 144 may also invoke model 142 again for each candidate target entity where such invocation does not include values for the entity-specific interaction features (pertaining to the source entity). Instead, the values for those features may be 0. Such a second set of invocations result in a general (or source entity-agnostic) score for each candidate target entity. However, if the second set of invocations have been made earlier in order to generate scores for the same candidate target entities with respect to one or more other source entities, then the second set of invocations do not need to be made again for these candidate target entities.

For example, given a source entity A and three candidate target entities T1, T2, T3, a general target entity score (TS) is generated for each target entity and source entity-specific scores are generated with respect to the three target entities: A-T1, A-T2, and A-T3. Thereafter, a final score for each target-source pair is computed by dividing each source entity-specific score by the general target entity score: A-T1/TS1; A-T2/TS2; A-T3/TS3. The general target entity score of a target entity is the general preexisting interest to a source entity prior to specific interactions. Oftentimes, a final score of “1” indicates that the target entity is interested in the source entity more than the “average” source entity or more than a majority of source entities.

In practice, many source entity-target entity pairs might not have any entity specific-interaction features. In such cases, a source entity-specific score is not generated since that score would be identical to the corresponding target entity score. Therefore, in an embodiment, a determination is made (e.g., by model invoker 144) whether there is a non-zero value for any entity-specific interaction features. If not, then model 142 is not invoked in order to generate a source entity-specific score. Instead, a “final score” for the target-source pair may be assigned a value of “1.”

### Process Overview

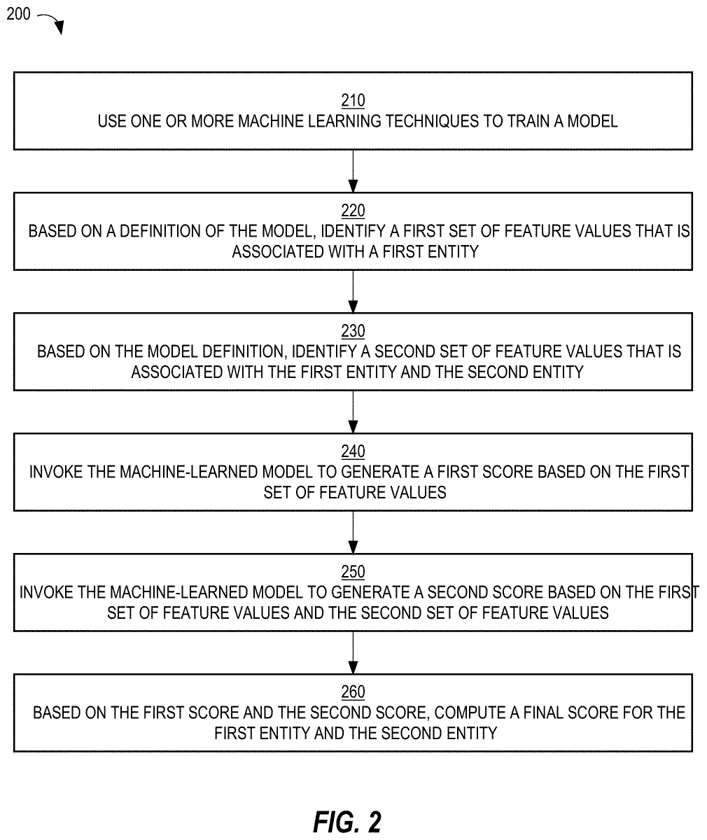

FIG. 2 is a flow diagram that depicts an example process 200 for generating prediction scores using a machine-learned model, in an embodiment. Process 200 may be implemented by different elements or components of server system 130.

At block 210, a model is trained based on training data using one or more machine learning techniques.

At block 220, based on a definition of the machine-learned model, a first set of feature values that is associated with a first (target) entity is identified. The first set of feature values correspond to non-interaction features and non-entity-specific interaction features, or features that do not pertain to interactions only between the first entity and a second (source) entity.

At block 230, based on the model definition, a second set of feature values that is associated with the first entity and the second entity is identified. The second set of feature values correspond to entity-specific interaction features, or features that pertain to interactions only between the first entity and the second entity.

At block 240, the machine-learned model is invoked to generate a first score based on the first set of feature values. In other words, the first set of feature values are input into the machine-learned model, which produces the first score.

At block 250, the machine-learned model is invoked to generate a second score based on the first set of feature values and the second set of feature values. In other words, the first set of feature values and the second set of feature values are input into the machine-learned model, which produces the second score, which is different than the first score.

At block 260, a final score is computed based on the first score and the second score. The final score is associated with the pair consisting of the first entity and the second entity. Block 260 may comprise computing a ratio between the second score and the first score. In the scenario where the second score is divided by the first score, the higher the final score above the value 1, the more likely the first entity is interested in the second entity more than a majority of other entities.

### Two-Model Approach

The above approach is a single-model approach where a single machine-learned model is invoked twice in order to compute a final score for a target entity-source entity pair. This has an advantage of defining and training a single model. In an alternative embodiment, two machine-learned models are trained: a general target entity model for producing general target entity scores and a source entity-specific model for producing source entity-specific scores, each for a different target entity. The general target entity model comprises non-interaction features and non-entity-specific interaction features, but not entity-specific interaction features. The source entity-specific model comprises non-interaction features and entity-specific interaction features, and, optionally, non-entity-specific interaction features. Therefore, one set of training data is generated for training one model and another set of training data is generated for training the other model. Thus, the training data for the general target entity model would not have any feature values for entity pair-specific interaction features, while the source entity-specific model would have feature values for entity pair-specific interaction features.

For a particular target entity-source entity pair, each model is invoked once to produce their respective scores, from which a final score is computed for the target entity-source entity pair. However, once a general target entity score is generated for a target entity, that score may be used in computing final scores for multiple target entity-source entity pairs (where the target entity in each pair is the same) without having to invoke the general target entity model again.

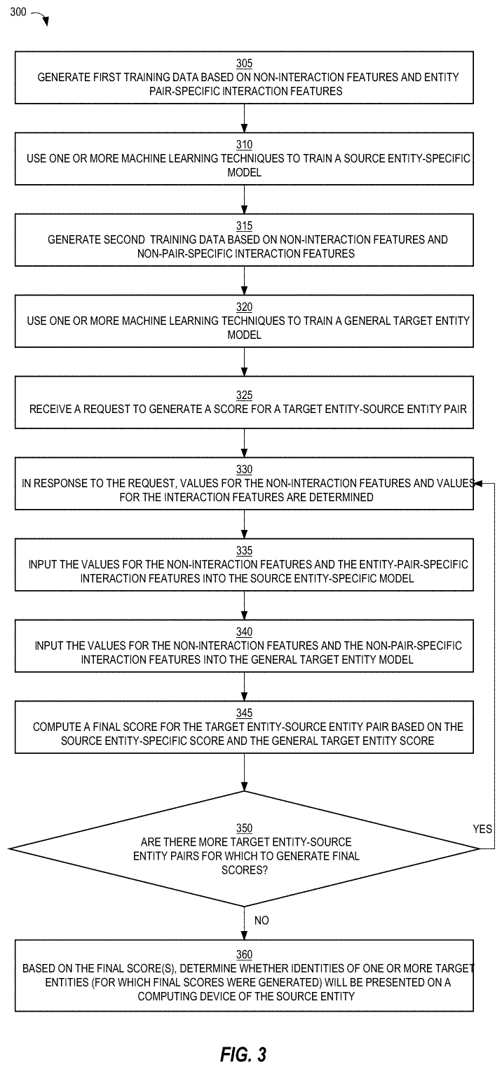

FIG. 3 is a flow diagram that depicts an example process 300 for generating prediction scores using the two-model approach, in an embodiment. Process 300 may be implemented by different elements or components of server system 130.

At block 305, first training data is generated based on non-interaction features and entity-specific interaction features. The first training data may also be generated based on non-entity-specific interaction features.

At block 310, one or more machine learning techniques are used to train a source entity-specific model. For example, linear regression is used to determine (or “learn”) coefficients for the set of features of the source entity-specific model.

At block 315, second training data is generated based on non-interaction features and non-entity-specific interaction features, but not entity-specific interaction features.

At block 320, one or more machine learning techniques are used to train a general target entity model. These techniques may or may not be the same as the machine learning techniques that are used to train the source entity-specific model.

At block 325, a request is received to generate a score for a target entity-source entity pair. Block 325 may involve receiving a content request from a computing device of the source entity indicated in the pair. Alternatively, block 325 may involve receiving a request from a program executing in server system 130 that is triggered on a regular basis, such as daily. Thus, final scores for different target entity-source entity pairs may be updated regularly.

At block 330, in response to the request, values for the non-interaction features and values for the interaction features are determined. Block 330 may involve retrieving, from entity profile data source 132 and online history data source 134, records pertaining to the target entity and the source entity and performing one or more aggregation operations on multiple retrieved records in order to generate values for some interaction features.

At block 335, the values for the non-interaction features and values for the entity-specific interaction features are input to the source entity-specific model, which outputs a source entity-specific score.

At block 340, the values for the non-interaction features and values for the non-entity-specific interaction features are input to the general target entity model, which outputs a general target entity score.

At block 345, a final score is computed for the target entity-source entity pair based on the source entity-specific score and the general target entity score. For example, the source entity-specific score is divided by the general target entity score.

At block 350, it is determined whether there are any more target entity-source entity pairs for which to generate final scores. If not, then process 300 proceeds to block 360. If so, then process 300 returns to block 330 where feature values for a different target entity are determined and/or generated. However, in a second iteration, block 340 may be skipped if the target entity is the same.

At block 360, it is determined, based on the final score(s), whether identities of one or more target entities (for which final scores were generated) will be presented on a computing device of the source entity, or a representative thereof. Additionally or alternatively, if multiple final scores are generated, then the final scores are used to rank content items (e.g., recommendations or notifications) associated with the target entities.

### Bucketizing Final Scores

In an embodiment, a final score is “bucketized” or assigned to one of multiple buckets based on the value of the final score. Each bucket is associated with a different range of (e.g., pre-defined) values. Example buckets include, in order of interest by a target entity in a source entity, “below baseline” (e.g., less than 0.9), “baseline” (e.g., between 0.9 and 1.1), “medium” (e.g., between 1.1 and 1.5), and “high” (e.g., greater than 1.5). Thus, target entities associated with final scores assigned to the “high” bucket are prioritized higher than target entities that associated with final scores assigned to the other buckets. Also, the bucket designation of a final score may indicate what data is included in a user interface that is presented/displayed on a computing device of the appropriate source entity. For example, if a final score is assigned to the “high” bucket, then a user interface that identifies the target entity may indicate a “High” interest category, indicating that the target entity has exhibited a high interest in the source entity.

Prioritizing a target entity may involve multiple automatic actions performed by server system 130, examples of which include assigning the target entity to a target audience of a content delivery operation or campaign, sending a personalized electronic message to a messaging account of the target entity, and sending a notification to the source entity identifying the target entity. Manual actions may involve reviewing historical engagement of the target entity via synced CRM records, identifying next opportunities, and reaching out to key decision makers via connection requests, electronic messages, introductions through third parties, or other means.

### User Interface

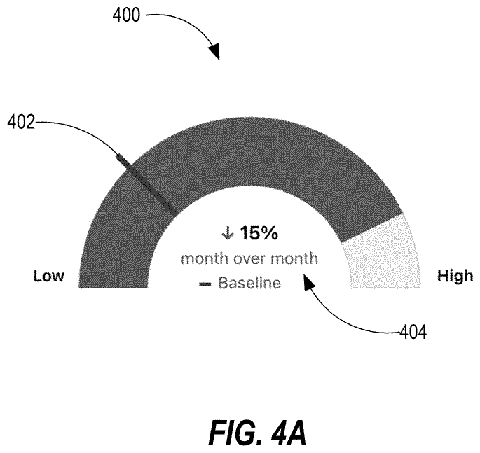

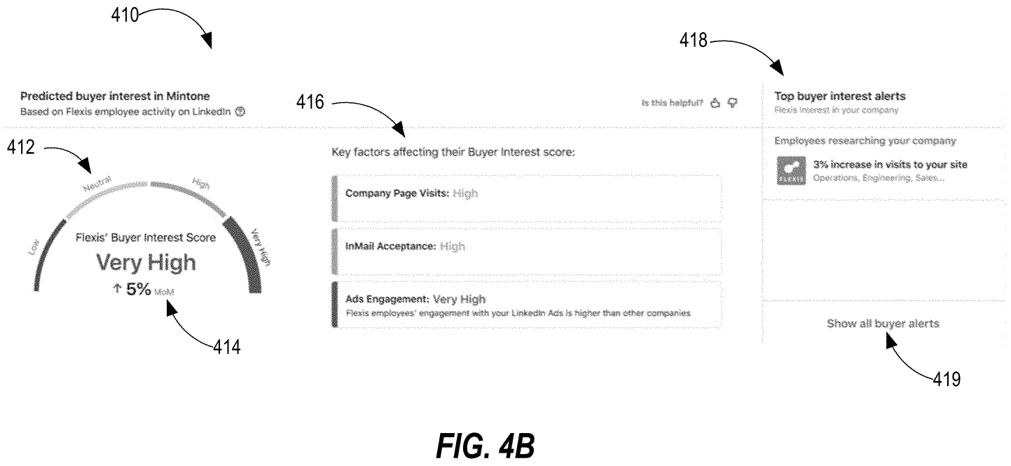

FIG. 4A and FIG. 4B are example graphics and user interfaces that indicate final scores representing interest related to a pair of entities, in an embodiment. A user interface is presented on a computing device of a user associated with the pertinent source entity. Such graphics may be presented automatically on a user interface of a computing device of a source entity or in response to a selection by a user of the computing device.

In FIG. 4A, a graphic 400 is an example graphic that indicates a final score between a target entity and a source entity. The shaded area of the semi-circle indicates that the final score is relatively high; therefore, the target entity has a moderately high interest in the source entity. Graphic 400 includes a line 402 that indicates a baseline score, which reflects a general interest in the target entity among multiple source entities and excludes pair-specific interaction features. Graphic 400 also includes trend data 404 that indicates that the final score is down 15% relative to a final score from the previous month. Therefore, even though the target entity's interest in the source entity is relatively high, that interest has decreased over time, possibly reflecting (a) fewer pair-specific interactions in the last month compared to the previous month, (b) more non-pair-specific interactions in the last month compared to the previous month, or (c) both (a) and (b).

In FIG. 4B, user interface 410 is an example user interface that includes a graphic 412 and factor data 416 that informs the source entity (“Mintone”) regarding factors that led to the final score associated with the target entity (“Flexis”). In this example, graphic 412 includes (1) a “Very High” interest category that is based on the final score and (2) increase data 414 that indicates how much the final score increased compared to the previous month. The “Very High” indication may be made using (a) the phrase/words and/or (b) the color, the shading, and/or the thickness of the portion of the semi-circle corresponding to the “Very High” interest category. In this example, both the phrase and the thickness indicators are used.

Factor data 416 indicates three main factors that went into the final score. One of those factors is a number of visits by employees of Flexis to a company page of Mintone. That company page may be hosted by an online social network provider, such as LinkedIn. The second of those factors is a message acceptance rate, which indicates a ratio of (a) the number of acceptances (by employees of Flexis) of messages from employees (or representatives) of Mintone to (b) the number of messages sent to employees of Flexis from employees (or representatives) of Mintone. The third of those factors is advertising or content engagement, which indicates how often employees of Flexis engage with content items (e.g., advertisements) from Mintone. For each of these three factors, factor data 416 indicates that interest related to those factors are high or “very high.” Thus, different factors may be associated with different Low/Neutral/High/Very High interest categories. The factor-specific interest categories may be determined by comparing (1) feature values pertaining to the target entity-source entity pair and corresponding to a factor to (2) average feature values (also corresponding to the factor) pertaining to other pairs involving the same target entity but different source entities.

User interface 410 also includes alert data 418 that indicates alerts that the target entity triggers based on activity of the target entity (or employees therefore). Alert data 418 includes a specific alert that employees of Flexis have had a 3% increase visits to a website of Mintone.

The color of each UI element may also indicate one of the Low/Neutral/High/Very High interest categories. For example, UI elements corresponding to the Low interest category may have a red color, UI elements corresponding to the Neutral interest category may have a gray color, UI elements corresponding to the High interest category may have a light green color, and UI elements corresponding to the Very High interest category may have a dark green color.

User interface 410 also includes an alert button 420 that, if selected, causes user interface 410 to be updated to include multiple alerts related to interactions between Flexis and Mintone.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

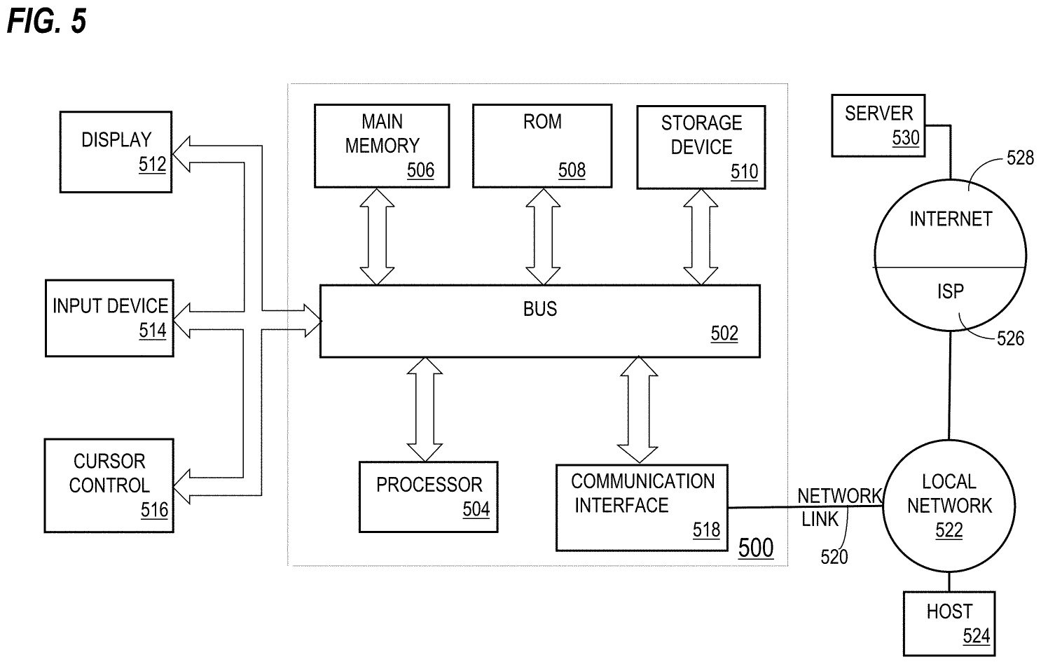

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or solid-state drive is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 510. Volatile media includes dynamic memory, such as main memory 506. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
identifying first values for a set of non-pair-specific interaction features that are associated with a first entity;
identifying second values for a set of pair-specific interaction features that are associated with (a) the first entity and (b) a second entity that is different than the first entity;
generating, by a machine-learned model that has been trained based on the set of non-pair-specific interaction features and the set of entity pair-specific interaction features, a first score based on the first values;
generating, by the machine-learned model, a second score based on the first values and the second values, wherein the second score is different than the first score;
computing a final score for the first entity-second entity pair based on the first score and the second score;
based on the final score, causing data about the first entity to be transmitted over a computer network to be presented on a computing device associated with the second entity;
wherein the method is performed by one or more computing devices.

2. The method of claim 1, further comprising:
identifying third values that is associated with the first entity and a third entity that is different than the second entity;
generating, by the machine-learned model, a third score based on the first values and the third values, wherein the third score is different than the first score and the second score;
computing a final score for the first entity-third entity pair based on the first score and the third score.

3. The method of claim 1, wherein computing the final score comprises computing a ratio of the second score to the first score.

4. The method of claim 1, further comprising:
storing scoring bucket data about a plurality of scoring buckets, each scoring bucket corresponding to a different range of scores;
assigning the final score to a scoring bucket, of the plurality of scoring buckets, that corresponds to a range of scores that includes the final score;
based on the scoring bucket, performing one or more actions.

5. The method of claim 4, automatically performing the one or more actions comprises one or more of:
assigning the target entity to a target audience of a content delivery operation;
sending an electronic message to a messaging account of the target entity; or sending, to an account of the source entity, a notification that identifies the target entity.

6. The method of claim 1, wherein:
the first entity comprises a plurality of users that have one or more attributes in common;
identifying the first values comprises:
for each user of the plurality of users, identifying a set of feature values that is associated with said each user;
aggregating the sets of feature values that are associated with the plurality of users to generate the first values.

7. The method of claim 1, wherein:
the second entity comprises a plurality of users that have one or more attributes in common;
identifying the second values comprises:
for each user of the plurality of users, identifying a set of feature values that is associated with said each user and the first entity;
aggregating the sets of feature values that are associated with the plurality of users to generate the second values.

8. The method of claim 1, wherein the training data comprises a plurality of training instances, wherein each training instance includes a label that indicates whether the first entity performed one or more of the following: accepted an electronic message invitation, filled out a digital form, acquired a particular item, visited a particular webpage, or selected a particular content item.

9. The method of claim 1, further comprising:
causing, to be transmitted over the computer network to be presented on the computing device, factor data that (1) identifies a plurality of factors that affect the final score and (2) includes an interest category of each factor of the plurality of factors based on interactions between the first entity and the second entity.

10. One or more storage media storing instructions which, when executed by one or more processors, cause:
identifying first values for a set of non-pair-specific interaction features that are associated with a first entity;
identifying second values for a set of pair-specific interaction features that are associated with (a) the first entity and (b) a second entity that is different than the first entity;
generating, by a machine-learned model that has been trained based on the set of non-pair-specific interaction features and the set of entity pair-specific interaction features, a first score based on the first values;
generating, by the machine-learned model, a second score based on the first values and the second values, wherein the second score is different than the first score;
computing a final score for the first entity-second entity pair based on the first score and the second score;
based on the final score, causing data about the first entity to be transmitted over a computer network to be presented on a computing device associated with the second entity.

11. The one or more storage media of claim 10, wherein the instructions, when executed by the one or more processors, further cause:
identifying third values that is associated with the first entity and a third entity that is different than the second entity;
generating, by the machine-learned model, a third score based on the first values and the third values, wherein the third score is different than the first score and the second score;
computing a final score for the first entity-third entity pair based on the first score and the third score.

12. The one or more storage media of claim 10, wherein computing the final score comprises computing a ratio of the second score to the first score.

13. The one or more storage media of claim 10, wherein the instructions, when executed by the one or more processors, further cause:
storing scoring bucket data about a plurality of scoring buckets, each scoring bucket corresponding to a different range of scores;
assigning the final score to a scoring bucket, of the plurality of scoring buckets, that corresponds to a range of scores that includes the final score;
based on the scoring bucket, performing one or more actions.

14. The one or more storage media of claim 13, automatically performing the one or more actions comprises one or more of:
assigning the target entity to a target audience of a content delivery operation;
sending an electronic message to a messaging account of the target entity; or sending, to an account of the source entity, a notification that identifies the target entity.

15. The one or more storage media of claim 10, wherein:
the first entity comprises a plurality of users that have one or more attributes in common;
identifying the first values comprises:
for each user of the plurality of users, identifying a set of feature values that is associated with said each user;
aggregating the sets of feature values that are associated with the plurality of users to generate the first values.

16. The one or more storage media of claim 10, wherein:
the second entity comprises a plurality of users that have one or more attributes in common;
identifying the second values comprises:
for each user of the plurality of users, identifying a set of feature values that is associated with said each user and the first entity;
aggregating the sets of feature values that are associated with the plurality of users to generate the second values.

17. The one or more storage media of claim 10, wherein the training data comprises a plurality of training instances, wherein each training instance includes a label that indicates whether the first entity performed one or more of the following: accepted an electronic message invitation, filled out a digital form, acquired a particular item, visited a particular webpage, or selected a particular content item.

18. The one or more storage media of claim 10, wherein the instructions, when executed by the one or more processors, further cause:
causing, to be transmitted over the computer network to be presented on the computing device, factor data that (1) identifies a plurality of factors that affect the final score and (2) includes an interest category of each factor of the plurality of factors based on interactions between the first entity and the second entity.

19. A system comprising:
one or more processors;
one or more storage media storing instructions which, when executed by the one or more processors, cause:
identifying first values for a set of non-pair-specific interaction features that are associated with a first entity;
identifying second values for a set of pair-specific interaction features that are associated with (a) the first entity and (b) a second entity that is different than the first entity;
generating, by a machine-learned model that has been trained based on the set of non-pair-specific interaction features and the set of entity pair-specific interaction features, a first score based on the first values;
generating, by the machine-learned model, a second score based on the first values and the second values, wherein the second score is different than the first score;
computing a final score for the first entity-second entity pair based on the first score and the second score;
based on the final score, causing data about the first entity to be transmitted over a computer network to be presented on a computing device associated with the second entity.

20. The system of claim 19, wherein the instructions, when executed by the one or more processors, further cause:
identifying third values that is associated with the first entity and a third entity that is different than the second entity;
generating, by the machine-learned model, a third score based on the first values and the third values, wherein the third score is different than the first score and the second score;
computing a final score for the first entity-third entity pair based on the first score and the third score.
